(19) United States
(12) Patent Application Publication
(10) Pub. No.: US 2011/0038171 A1
(43) Pub. Date: Feb. 17, 2011

(54) VEHICLE LIGHT

(76) Inventor: Mitsuhiro Uchida, Tokyo (JP)

Correspondence Address: KENEALY VAIDYA LLP, 515 EAST BRADDOCK RD SUITE B, Alexandria, VA, 22314, US

(21) Appl. No.: 12/850,401

(22) Filed: Aug. 4, 2010

(30) Foreign Application Priority Data
Aug. 4, 2009 (JP) 2009-181573

(51) Int. Cl. F21V 19/02

(52) U.S. Cl. 362/519

(57) ABSTRACT

A vehicle light can be configured to form a low-beam light distribution pattern on a virtual plane having a horizontal line and a vertical line as reference lines, the low-beam light distribution pattern including at least a first partial light distribution pattern having a horizontal cut-off line and a second partial light distribution pattern having a cut-off line inclined by a predetermined angle with respect to the horizontal line. The vehicle light can include an LED light source having an optical axis and disposed so that the optical axis thereof is directed in a horizontal direction, and a reflector formed of a revolved paraboloid and having a first reflecting surface disposed on the optical axis of the LED light source so as to face to the LED light source and a second reflecting surface disposed outside of the first reflecting surface and at a farther position away from the light source than the first reflecting surface. The first reflecting surface can be a revolved paraboloid as a whole, having a focus disposed near the LED light source so as to diffuse and reflect, in the horizontal direction, light emitted from the LED light source and reaching the first reflecting surface, thereby forming the first partial distribution pattern. The second reflecting surface can be a revolved paraboloid as a whole, having a focus disposed near the LED light source so as to reflect light emitted from the LED light source and reaching the second reflecting surface and to converge the light to an intersection of the horizontal line and the vertical line, thereby forming the second partial distribution pattern.

This application claims the priority benefit under 35 U.S.C. §119 of Japanese Patent Application No. 2009-181573 filed on Aug. 4, 2009, which is hereby incorporated in its entirety by reference.

### TECHNICAL FIELD

The presently disclosed subject matter relates to a vehicle light, and in particular, to a vehicle light having an LED light source and a reflector configured to form a low-beam light distribution pattern by reflecting the light emitted from the LED light source.

### BACKGROUND ART

A conventional vehicle light 200 (such as described in Japanese Patent Application Laid-Open No. 2004-303639 or the corresponding U.S. Application Laid-Open No. 2004/0252517A1) is illustrated in FIG. 1. The vehicle light 200 can include two LED light sources 210 disposed on either side of the standard axis AX of the vehicle light 200, and two reflecting surfaces 220 disposed corresponding to the two LED light sources 210, respectively. The conventional vehicle light 200 can be configured such that the respective LED light sources 210 emit light to the corresponding reflecting surfaces 220 and the reflecting surfaces 220 can reflect the received light to the front direction, thereby forming a low-beam light distribution pattern composed of a plurality of partial light distribution patterns, as shown in FIG. 2.

However, because the vehicle light 200 described above has the two LED light sources 210 disposed on either side of the standard axis AX thereof and the reflecting surfaces 220 corresponding to the LED light sources 210, the parts number is relatively high, thereby resulting in increased total cost for manufacture. Furthermore, as the vehicle light 200 has separate optical systems on either side of the standard axis AX thereof, the size of the light 200 may be undesirable due to its large footprint or required volume.

In the conventional vehicle light, the low-beam light distribution pattern can be obtained by synthesizing a plurality of partial light distribution patterns. Accordingly, the light intensity distribution near the center area may be insufficient, thereby making the distant visibility deteriorate.

Furthermore, when the LED light sources disposed on either side of the standard axis AX of the vehicle light are viewed from the front side of the vehicle light, the light sources can be directly observed, so that the direct light from the LED light source may become “glare light” or other generally undesirable light.

### SUMMARY

The presently disclosed subject matter was devised in view of these and other problems and features in association with the conventional art. According to an aspect of the presently disclosed subject matter, a vehicle light can be produced with a reduced parts number, thereby decreasing production cost. Furthermore, according to another aspect of the presently disclosed subject matter, the vehicle light can be made compact while the reduction in the light utilization efficiency can be prevented or suppressed. According to still another aspect of the presently disclosed subject matter, when viewed from its front side, the LED light source can be prevented from direct observation, thereby suppressing the occurrence of glare light.

According to yet another aspect of the presently disclosed subject matter, a vehicle light can form a low-beam light distribution pattern on a virtual plane having a horizontal line and a vertical line as reference lines, the low-beam light distribution pattern including at least a first partial light distribution pattern having a horizontal cut-off line and a second partial light distribution pattern having a cut-off line inclined by a predetermined angle with respect to the horizontal line. The vehicle light can include an LED light source having an optical axis and disposed so that the optical axis thereof is directed in a horizontal direction. The vehicle light can also include a reflector formed of a revolved paraboloid and having a first reflecting surface disposed on the optical axis of the LED light source so as to face towards the LED light source and a second reflecting surface disposed outside of the first reflecting surface and at a farther position away from the light source than the first reflecting surface. In this configuration, the first reflecting surface can be a revolved paraboloid as a whole, having a focus disposed near the LED light source so as to diffuse and reflect, in the horizontal direction, light emitted from the LED light source and reaching the first reflecting surface, thereby forming the first partial distribution pattern. The second reflecting surface can be a revolved paraboloid as a whole, having a focus disposed near the LED light source so as to reflect light emitted from the LED light source and reaching the second reflecting surface and to converge the light to an intersection of the horizontal line and the vertical line, thereby forming the second partial distribution pattern.

According to the above aspect of the presently disclosed subject matter, the reflecting surfaces, including the first and second reflecting surfaces, corresponding to the two reflecting surfaces conventionally disposed on either side of the standard axis are disposed only on a single side of the LED light source, and accordingly, the LED light source can be disposed only on a single or same side rather than the conventional LED light sources which are disposed on either side of the standard axis. This configuration can reduce the parts number, thereby resulting in a decrease in the production cost as well as many other benefits.

In the vehicle light according to the above aspect of the presently disclosed subject matter, the second reflecting surface can have a focal length larger than that of the first reflecting surface, and the focal length of the second reflecting surface may be 3 mm to 5 mm larger than that of the first reflecting surface.

Since the focal distance of the second reflecting surface can be set to be larger than the focal distance of the first reflecting surface, the second reflecting surface can reflect and converge the light to a greater degree than the first reflecting surface. Accordingly, the second reflecting surface can form the second partial light distribution pattern with high intensity, similar to a spot light, which can be suitable for the low-beam light distribution pattern. This can improve distance visibility.

The vehicle light according to the above aspect and the like of the presently disclosed subject matter can further include an LED light source supporting portion for holding the LED light source, and a third reflecting surface disposed outside of the first reflecting surface and near the LED light source. The third reflecting surface can reflect light, emitted from the LED light source and directly reaching the third reflecting surface and/or the light reflected by any of the first and the second reflecting surfaces, to a direction where the light does not interfere with the LED light source and the LED light source supporting portion, thereby forming a third partial light distribution pattern being a part of the low-beam light distribution pattern.

The third reflecting surface can be disposed corresponding to the first reflecting surface, and accordingly, the light reflected by the first reflecting surface to the direction where the reflected light may interfere with the LED light source and the LED light source supporting portion can be reflected by the third reflecting surface to the direction where the reflected light does not interfere with the LED light source and the LED light source supporting portion. Instead, the reflected light can be used as the third partial light distribution pattern for forming the low-beam light distribution pattern. Accordingly, the light utilization efficiency of the vehicle light can be improved.

The vehicle light according to the above aspect or the like of the presently disclosed subject matter can include an optical axis extending along a front-to-rear direction of a vehicle on which the vehicle light is mounted. The first reflecting surface and the second reflecting surface can extend substantially along the optical axis of the vehicle light, and the LED light source can be disposed so as to be inclined rearward with respect to the optical axis of the vehicle light. In this instance, an angle by which the LED light source is disposed is 10 degrees to 20 degrees rearward, and possibly, 15 degrees rearward.

Accordingly, as the LED light source can be disposed with a posture inclined by a predetermined angle rearward, and the size in depth (front-to-rear) and width directions of the reflector can be reduced. Furthermore, even when such a small-sized reflector is adopted, the projected light can be sufficiently captured by the reflector, thereby ensuring that the required light intensity can be the same as that when the LED light source is not inclined.

Furthermore, in the above configuration, the LED light source in the inclined posture can emit light to the reflector effectively while the light with the strongest luminous intensity (for example, the range of half-width of 62°) from the LED light source can be projected onto the reflector.

Furthermore, when the vehicle light is viewed from the front side thereof, the light source cannot be directly observed (or is difficult to be observed). Thereby, any glare light caused by directly observed light emitted from the LED light source can be prevented or suppressed.

### BRIEF DESCRIPTION OF DRAWINGS

These and other characteristics, features, and advantages of the presently disclosed subject matter will become clear from the following description with reference to the accompanying drawings, wherein:

FIG. 1 a horizontal cross sectional view illustrating the configuration of a conventional vehicle light;

FIG. 2 is a diagram illustrating a low-beam light distribution pattern formed by the conventional vehicle light;

FIG. 3 is a perspective view illustrating a vehicle light according to one exemplary embodiment made in accordance with principles of the presently disclosed subject matter;

FIG. 4 is a front view of the vehicle light of FIG. 3;

FIG. 5 is a horizontal top cross sectional view of the vehicle light of FIG. 3;

FIG. 6 is a horizontal top cross sectional view of the vehicle light of FIG. 3, illustrating an exemplary manner of illumination;

FIGS. 7A to 7C are diagrams illustrating partial light distribution patterns P3, P1 and P2 formed by third, first and second reflecting surfaces 23, 21 and 22, respectively, of the vehicle light of FIG. 3; and

FIG. 8 is a diagram illustrating a low-beam light distribution pattern formed by the partial light distribution patterns P1 to P3.

### DESCRIPTION OF EXEMPLARY EMBODIMENTS

A description will now be made below to vehicle lights made in accordance with principles of the presently disclosed subject matter with reference to the accompanying drawings by way of exemplary embodiments.

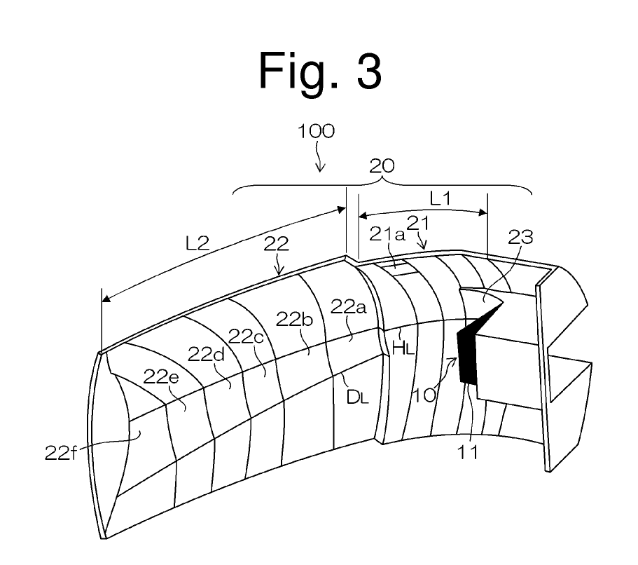

A vehicle light 100 of the present exemplary embodiment can be applied to a headlight for a vehicle, including an automobile or motorcycle. As shown in FIGS. 3 to 5, the vehicle light 100 can include an LED light source 10 and a reflector 20.

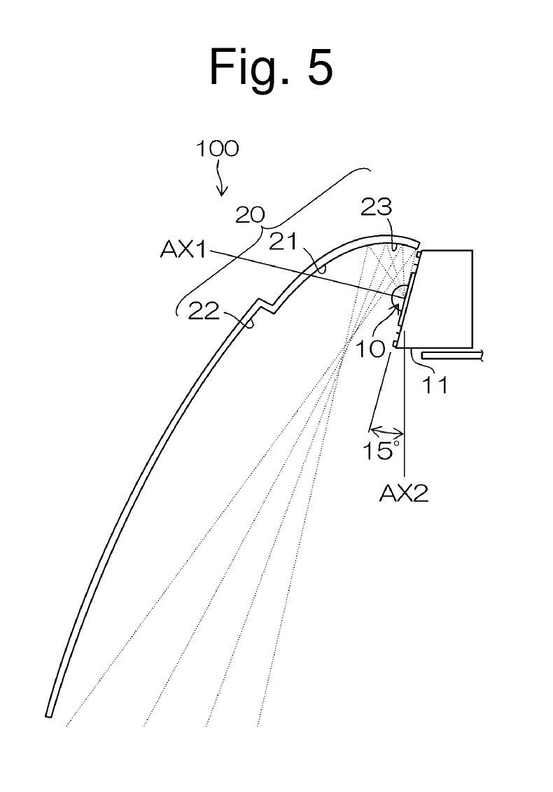

As shown in FIG. 5, the LED light source 10 can be supported by an LED light source supporting portion 11 with an optical axis AX1 of the LED light source 10 being generally horizontally directed, while the posture of the LED light source 10 is set to face towards the reflector 20 and to be inclined rearward by a predetermined angle. In FIG. 5, when the vehicle light 10 has an optical axis AX2 extending in the front-to-rear direction of the vehicle, the vehicle light 10 can be inclined rearward by an angle of 10° to 20°, and possibly 15°. In other words, the optical axis AX1 of the LED light source can be inclined rearward at an angle of approximately 100° to 110° with respect to the optical axis AX2 of the vehicle light, and possibly 105° (as shown in FIG. 5).

As shown in FIGS. 3 to 5, the reflector 20 can include a first reflecting surface 21 disposed on the optical axis AX1 of the LED light source 10 so as to face towards the light source (including a sub-reflecting surface 21a for forming an over-head light distribution pattern), a second reflecting surface 22 disposed outside of the first reflecting surface and at a farther position away from the light source than the first reflecting surface 21, and a third reflecting surface 23. These reflecting surfaces 21, 22 and 23 can be integrally formed from a single continuous material to be a substantial revolved paraboloid as a whole.

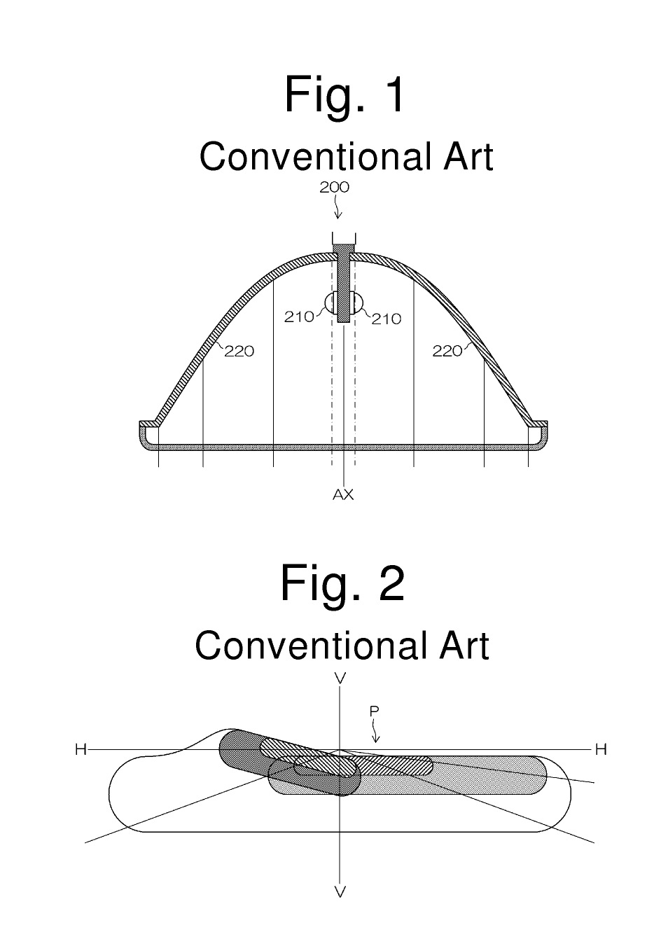

In the conventional vehicle light, two reflecting surfaces are disposed on either side of a standard axis (see FIG. 1). According to the above aspect of the presently disclosed subject matter, the reflecting surfaces (first and second reflecting surfaces 21 and 22) corresponding to the conventional two reflecting surfaces can be disposed only on a single side, and accordingly, the LED light source 10 can be disposed only on the same side as the reflector 20 (as shown in FIGS. 3 to 5) as compared to the conventional LED light sources located on either side of the standard axis. This configuration can reduce the part number, thereby resulting in a decrease in production cost.

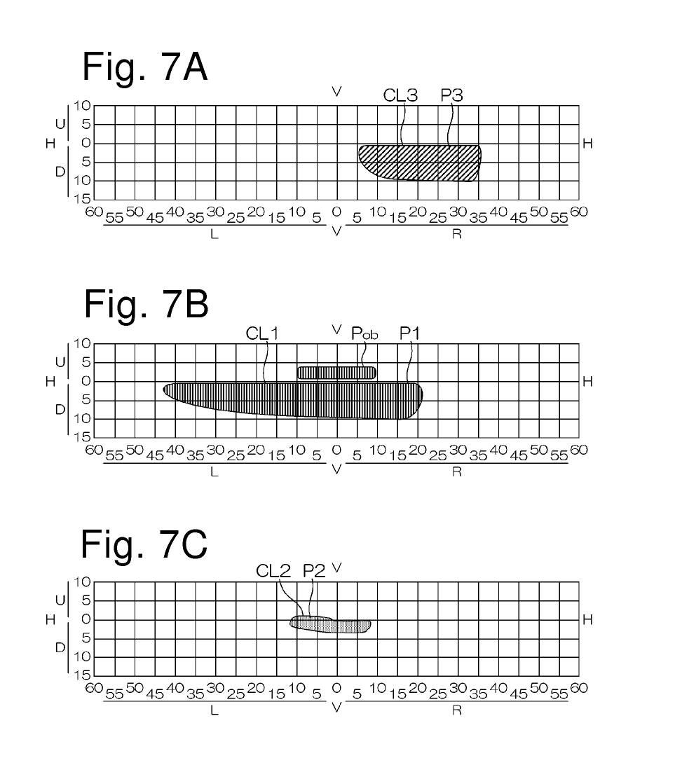

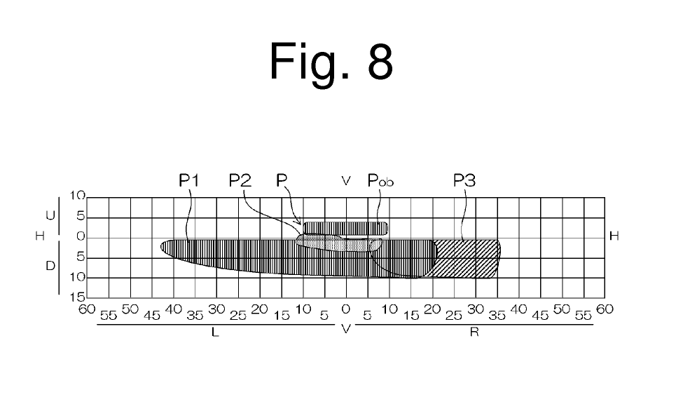

The reflecting surfaces 23, 21 and 22 can be configured (designed) so that they can reflect light from the LED light source 10 or the like, thereby forming the partial light distribution patterns P3, P1, and P2, respectively (see FIGS. 7A, 7B and 7C), constituting the low-beam light distribution pattern P (see FIG. 8) as determined on a virtual plane having a horizontal line H-H and a vertical line V-V as reference lines.

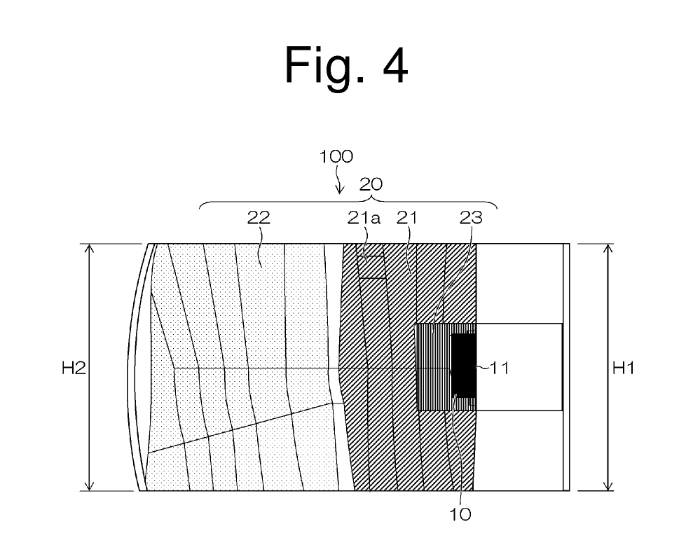

Specifically, the first reflecting surface 21 can include a plurality of reflecting surface (for example, cylindrical reflecting surfaces extending vertically). In this case, the first reflecting surface 21 can be a revolved paraboloid as a whole, having a focus disposed near the LED light source 10. The first reflecting surface 21 configured as described above can diffuse and reflect, in the horizontal direction, light that is emitted from the LED light source 10 and reaches the first reflecting surface 21. The reflected light can have a horizontal cut-off line CL1 as defined by a horizontal line H_{L} so as to form a first partial light distribution pattern P1 that is horizontally wide as shown in FIG. 7B. The height H1 and the arc length L1 of the first reflecting surface 21 can be set to respective appropriate values in relation to the light intensity required to form the first partial light distribution pattern P1 for constituting a part of the entire light distribution pattern P (see FIGS. 3 and 4).

Further, the first reflecting surface 21 can be formed such that the light reflected by a portion of the reflecting surface 21 below the horizontal line H_{L} is directed to the first partial light distribution pattern P1. In this case, the portion of the reflecting surface 21 below the horizontal line H_{L} can be bent along the horizontal line H_{L}.

The first reflecting surface 21 can include at is upper area the sub-reflecting surface 21a. The sub-reflecting surface 21a can reflect light from the LED light source 10 to form an additional light distribution pattern Pob for illuminating advertisement or roadside displays (or so-called over-head light distribution pattern) as shown in FIG. 7B.

The second reflecting surface 22 can include a plurality of reflecting surfaces 22a to 22c (for example, planar reflecting surfaces) and other reflecting surfaces 22d to 22f, and can be a revolved paraboloid as a whole, having a focus disposed near the LED light source 10. The plurality of reflecting surfaces 22a to 22c can reflect light emitted from the LED light source 10 and converge the light to an intersection of the horizontal line H-H and the vertical line V-V on the virtual plane for the light distribution pattern. The reflected light can form the second partial distribution pattern P2, as shown in FIG. 7C, which can have a cut-off line CL2 as defined by the inclined line D_{L} by 15° with respect to the horizontal line H-H, and be converged similar to a spot light.

The other reflecting surfaces 22d to 22f can be disposed outside the reflecting surface 22c so as to adjust the degree of diffusion. The height H2 and the arc length L2 of the second reflecting surface 22 can be set to respective appropriate values in relation to the light intensity required to form the second partial light distribution pattern P2 for constituting a part of the entire light distribution pattern P (see FIGS. 3 and 4).

Further, the second reflecting surface 22 can be formed such that the light reflected by a portion of the reflecting surface 22 below the line D_{L} inclined by 15° with respect to the horizontal line H-H is directed to the second partial light distribution pattern P2. In this case, the portion of the reflecting surface 22 below the inclined line D_{L} can be bent along the inclined line D_{L}.

The second reflecting surface 22 can have a focal length (F value) larger than a focal length of the first reflecting surface 21, and more specifically, the focal length of the second reflecting surface 22 can be 3 mm to 5 mm larger than that of the first reflecting surface 21. This configuration can allow the second reflecting surface 22 to reflect and converge light more than the case where the focal distance thereof is the same as the first reflecting surface 21. Accordingly, the second reflecting surface 22 can form the second partial light distribution pattern P2 with high intensity similar to a spot light, which may be suitable for the low-beam light distribution pattern P (see FIG. 7C) as well as having a definite cut-off line CL2. This can improve distance visibility. Note that the boundary area between the first and second reflecting surfaces 21 and 22 can be directed horizontally frontward with respect to the optical axis AX1 of the LED light source 10 by 30° or less.

In the first reflecting surface 21 configured as described above, the LED light source 10 can be disposed so as to be inclined rearward with respect to the optical axis AX2 by a predetermined angle (for example, 15°). In this case, part of the light may be reflected by the first reflecting surface 21 to a direction where the reflected light may interfere with the LED light source 10 and the LED light source supporting portion 11, thereby being shielded by these portions 10 and 11. This may result in light loss.

In order to prevent this, the present exemplary embodiment can have the third reflecting surface 23 located outside of the first reflecting surface 21 and near the LED light source 10. In this case, the third reflecting surface 23 can be composed of a curved reflecting surface having a horizontal cross section forming an elliptic line and of which vertical cross section is a parabola. The third reflecting surface 23 configured as described above can reflect light, received directly from the LED light source 10 or reflected by the first reflecting surface 21, towards a direction where the reflected light does not interfere with the LED light source 10 and the LED light source supporting portion 11 (or the direction where the reflected light is not shielded by the LED light source 10 and the LED light source supporting portion 11). Then, the reflected light can be used as the third partial light distribution pattern P3 for constituting the low-beam light distribution pattern P having a horizontal cut-off line CL3 (see FIG. 7A). This can improve light utilization efficiency.

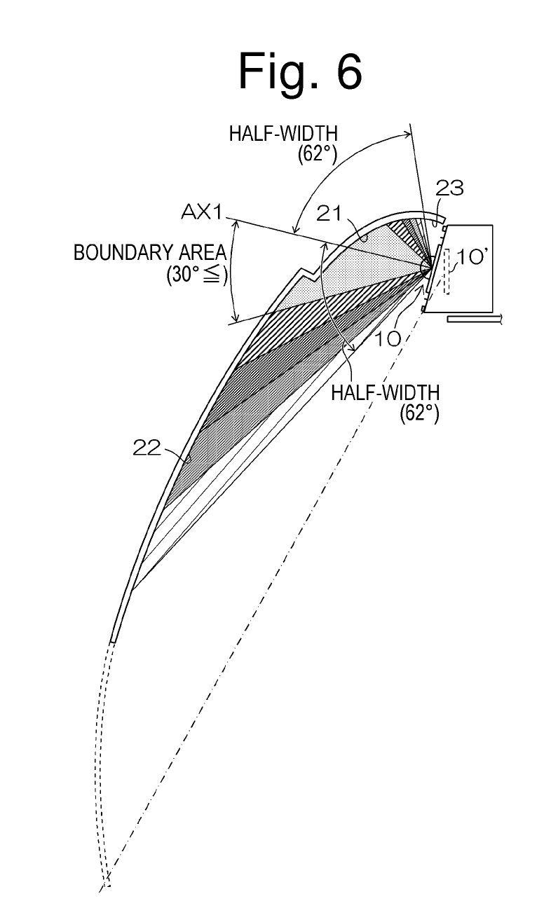

Next, a description will be given of another feature of the presently disclosed subject matter with reference to FIG. 6. FIG. 6 is a horizontal cross sectional view of the vehicle light according to the present exemplary embodiment of the presently disclosed subject matter, and illustrates the difference between the case where the LED light source is disposed in an inclined posture and the case where the LED light source is disposed along the optical axis of the vehicle light without being inclined. In the drawing, the solid line shows the vehicle light of the present exemplary embodiment while the dotted line shows the comparative reflector which is used in the comparative LED light source and disposed without being inclined.

As described above, the vehicle light 100 of the presently disclosed subject matter has the LED light source 10 whose posture is inclined rearward by a predetermined angle (for example, 15°). In this case, when compared with the case where the LED light source is not inclined (as denoted by 10′ shown by the dotted line in FIG. 6), the depth and width of the reflector 20 (including the first and second reflecting surfaces 21 and 22) can be made compact, thereby achieving size reduction for the entire vehicle light 100. In other words, even when such a small-sized reflector like this is employed, the required light can be captured, thereby ensuring a sufficient amount of light which can be the same as the case where the LED light source is not inclined. In order to ensure the same amount of light when the LED light source is not inclined as compared to the case when the LED light source is reclined, the reflector should have the size as shown by the dotted line (extending further frontward), meaning that the size reduction of the entire vehicle light cannot be achieved.

Furthermore, in the above configuration, the LED light source 10 in the inclined posture (for example, by 15°) can emit light to the reflector 20 effectively while the light with the strongest luminous intensity (for example, the range of half-width of 62°) from the LED light source 10 can be projected onto the reflector 20 (including the first and second reflecting surfaces 21 and 22) (see FIG. 6).

Furthermore, since the LED light source 10 is disposed in the inclined posture by a predetermined angle (for example, by 15°), when the vehicle light 100 is viewed from the front side thereof, the LED light source 10 may not be able to be directly observed (or is difficult to be observed). Thereby, any glare light caused by the directly observed light emitted from the LED light source 10 can be prevented or suppressed.

In the conventional vehicle light, two reflecting surfaces are disposed on either side of the standard axis (see FIG. 1). However, as described above, in the vehicle light 100 of the present exemplary embodiment, the reflecting surfaces (first and second reflecting surfaces 21 and 22) corresponding to the conventional two reflecting surfaces can be disposed only on a single (same) side, and correspondingly, the LED light source 10 can be disposed only on the same side as the reflector 20 (as shown in FIGS. 3 to 5) rather than the conventional LED light sources which are typically located on either side of the standard axis. This configuration can reduce the parts number, thereby resulting in a decrease in production cost.

The second reflecting surface 22 can have a focal length (F value) larger than a focal length of the first reflecting surface 21. This configuration can allow the second reflecting surface 22 to reflect and converge light to a greater degree than the case where the focal distance thereof is the same as the first reflecting surface 21. Accordingly, the second reflecting surface 22 can form the second partial light distribution pattern P2 with high intensity similar to a spot light, which may be suitable for the low-beam light distribution pattern P (see FIG. 7C) as well as having a definite cut-off line CL2. This can improve distance visibility.

The third reflecting surface 23 can be disposed to face towards the first reflecting surface 21, and accordingly, the light reflected by the first reflecting surface 21 to a direction where the reflected light interferes with the LED light source 10 and the LED light source supporting portion 11 can be reflected by the third reflecting surface 23 to the direction where the reflected light does not interfere with the LED light source 10 and the LED light source supporting portion 11. Therefore, the reflected light can be used as the third partial light distribution pattern P3 for constituting part of the low-beam light distribution pattern P. This can improve the light utilization efficiency.

Furthermore, since the LED light source is disposed in an inclined posture rearward by a predetermined angle, the depth and width of the reflector 20 can be made compact, thereby achieving size reduction of the entire vehicle light 100. In addition to this, even when such a small-sized reflector like this is employed, the required light can be captured, thereby ensuring a sufficient amount of light, such as the case when the LED light source is not inclined.

Furthermore, in the above vehicle light 100, the LED light source 10 in the inclined posture can emit light to the reflector 20 effectively while the light with the strongest luminous intensity (for example, the range of half-width of 62°) from the LED light source 10 can be projected onto the reflector 20.

Furthermore, when the vehicle light 100 is viewed from the front side thereof, the LED light source 10 cannot be directly observed (or is difficult to be observed). Thereby, glare light caused by the directly observed light emitted from the LED light source 10 can be prevented or suppressed.

It will be apparent to those skilled in the art that various modifications and variations can be made in the present invention without departing from the spirit or scope of the present invention. Thus, it is intended that the present invention cover the modifications and variations of the present invention provided they come within the scope of the appended claims and their equivalents. All related art references described above are hereby incorporated in their entirety by reference.

What is claimed is:

1. A vehicle light configured to form a low-beam light distribution pattern on a virtual plane having a horizontal line and a vertical line as reference lines, the low-beam light distribution pattern including at least a first partial light distribution pattern having a horizontal cut-off line and a second partial light distribution pattern having a cut-off line inclined by a predetermined angle with respect to the horizontal line, the vehicle light comprising:
an LED light source having an optical axis and disposed so that the optical axis is directed in a substantially horizontal direction; and
a reflector formed of a revolved paraboloid and having a first reflecting surface disposed on the optical axis of the LED light source so as to face towards the LED light source, and a second reflecting surface disposed outside of the first reflecting surface and at a position farther away from the light source than a position of the first reflecting surface, wherein
the first reflecting surface is a revolved paraboloid as a whole, having a focus disposed substantially at the LED light source so as to diffuse and reflect, in the horizontal direction, light emitted from the LED light source, thereby forming the first partial distribution pattern, and
the second reflecting surface is a revolved paraboloid as a whole, having a focus disposed substantially at the LED light source so as to reflect light emitted from the LED light source and to converge the light towards an intersection of the horizontal line and the vertical line, thereby forming the second partial distribution pattern.

2. The vehicle light according to claim 1, wherein the second reflecting surface has a focal length larger than a focal length of the first reflecting surface.

3. The vehicle light according to claim 1, wherein the second reflecting surface has a focal length 3 mm to 5 mm larger than a focal length of the first reflecting surface.

4. The vehicle light according to claim 1, further comprising:
an LED light source supporting portion configured to hold the LED light source; and
a third reflecting surface disposed outside of the first reflecting surface and substantially at the LED light source, the third reflecting surface configured to reflect light, the light reflected by the third reflecting surface including at least one of light emitted from the LED light source and light reflected by any of the first reflecting surface and the second reflecting surface, towards a direction where the light reflected by the third reflecting surface does not intersect with the LED light source and the LED light source supporting portion, thereby forming a third partial light distribution pattern being a part of the low-beam light distribution pattern.

5. The vehicle light according to claim 2, further comprising:
an LED light source supporting portion configured to hold the LED light source; and
a third reflecting surface disposed outside of the first reflecting surface and substantially at the LED light source, the third reflecting surface configured to reflect light, the light reflected by the third reflecting surface including at least one of light emitted from the LED light source and light reflected by any of the first reflecting surface and the second reflecting surface, towards a direction where the light reflected by the third reflecting surface does not intersect with the LED light source and the LED light source supporting portion, thereby forming a third partial light distribution pattern being a part of the low-beam light distribution pattern.

6. The vehicle light according to claim 3, further comprising:
an LED light source supporting portion configured to hold the LED light source; and
a third reflecting surface disposed outside of the first reflecting surface and substantially at the LED light source, the third reflecting surface configured to reflect light, the light reflected by the third reflecting surface including at least one of light emitted from the LED light source and light reflected by any of the first reflecting surface and the second reflecting surface, towards a direction where the light reflected by the third reflecting surface does not intersect with the LED light source and the LED light source supporting portion, thereby forming a third partial light distribution pattern being a part of the low-beam light distribution pattern.

7. The vehicle light according to claim 1, wherein the vehicle light includes an optical axis configured to extend along a front-to-rear direction of a vehicle on which the vehicle light is mounted, and wherein the first reflecting surface and the second reflecting surface extend substantially along the optical axis of the vehicle light, and wherein the optical axis of the LED light source is disposed so as to be inclined rearward at an angle with respect to the optical axis of the vehicle light.

8. The vehicle light according to claim 2, wherein the vehicle light includes an optical axis configured to extend along a front-to-rear direction of a vehicle on which the vehicle light is mounted, and wherein the first reflecting surface and the second reflecting surface extend substantially along the optical axis of the vehicle light, and wherein the optical axis of the LED light source is disposed so as to be inclined rearward at an angle with respect to the optical axis of the vehicle light.

9. The vehicle light according to claim 3, wherein the vehicle light includes an optical axis configured to extend along a front-to-rear direction of a vehicle on which the vehicle light is mounted, and wherein the first reflecting surface and the second reflecting surface extend substantially along the optical axis of the vehicle light, and wherein the optical axis of the LED light source is disposed so as to be inclined rearward at an angle with respect to the optical axis of the vehicle light.

10. The vehicle light according to claim 4, wherein the vehicle light includes an optical axis configured to extend along a front-to-rear direction of a vehicle on which the vehicle light is mounted, and wherein the first reflecting surface and the second reflecting surface extend substantially along the optical axis of the vehicle light, and wherein the optical axis of the LED light source is disposed so as to be inclined rearward at an angle with respect to the optical axis of the vehicle light.

11. The vehicle light according to claim 5, wherein the vehicle light includes an optical axis configured to extend along a front-to-rear direction of a vehicle on which the vehicle light is mounted, and wherein the first reflecting surface and the second reflecting surface extend substantially along the optical axis of the vehicle light, and wherein the optical axis of the LED light source is disposed so as to be inclined rearward at an angle with respect to the optical axis of the vehicle light.

12. The vehicle light according to claim 6, wherein the vehicle light includes an optical axis configured to extend along a front-to-rear direction of a vehicle on which the vehicle light is mounted, and wherein the first reflecting surface and the second reflecting surface extend substantially along the optical axis of the vehicle light, and wherein the optical axis of the LED light source is disposed so as to be inclined rearward at an angle with respect to the optical axis of the vehicle light.

13. The vehicle light according to claim 7, wherein the angle by which the optical axis of the LED light source is disposed is 100 degrees to 110 degrees rearward.

14. The vehicle light according to claim 8, wherein the angle by which the optical axis of the LED light source is disposed is 100 degrees to 110 degrees rearward.

15. The vehicle light according to claim 9, wherein the angle by which the optical axis of the LED light source is disposed is 100 degrees to 110 degrees rearward.

16. The vehicle light according to claim 10, wherein the angle by which the optical axis of the LED light source is disposed is 100 degrees to 110 degrees rearward.

17. The vehicle light according to claim 11, wherein the angle by which the optical axis of the LED light source is disposed is 100 degrees to 110 degrees rearward.

18. The vehicle light according to claim 12, wherein the angle by which the optical axis of the LED light source is disposed is 100 degrees to 110 degrees rearward.

19. The vehicle light according to claim 7, wherein the angle by which the optical axis of the LED light source is disposed is 105 degrees rearward.

20. The vehicle light according to claim 8, wherein the angle by which the optical axis of the LED light source is disposed is 105 degrees rearward.

21. The vehicle light according to claim 9, wherein the angle by which the optical axis of the LED light source is disposed is 105 degrees rearward.

22. The vehicle light according to claim 10, wherein the angle by which the optical axis of the LED light source is disposed is 105 degrees rearward.

23. The vehicle light according to claim 11, wherein the angle by which the optical axis of the LED light source is disposed is 105 degrees rearward.

24. The vehicle light according to claim 12, wherein the angle by which the optical axis of the LED light source is disposed is 105 degrees rearward.
